(19) United States
(12) Patent Application Publication
(10) Pub. No.: US 2007/0253329 A1
(43) Pub. Date: Nov. 1, 2007

(54) Fabric manager failure detection

(76) Inventors: Mo Rooholamini, Gilbert, AZ (US); Patrick Thomson, Mesa, AZ (US)

Correspondence Address: INTEL CORPORATION;c/o INTELLEVATE, LLC, P.O. BOX 52050, MINNEAPOLIS, MN, 55402, US

(21) Appl. No.: 11/252,158

(22) Filed: Oct. 17, 2005

(51) Int. Cl. H04J 3/14

(52) U.S. Cl. 370/220

(57) ABSTRACT

In a switch fabric including an active fabric manager and a standby fabric manager, a method that includes setting a timer for a duration and resetting the timer based on detection of a heartbeat message from the standby fabric manager via a path in the switch fabric. If the heartbeat is not detected after the timer has expired then the method includes determining whether the standby fabric manager has failed based at least in part on a topology and failing over to another standby fabric manager if the standby fabric manager has failed. The method further includes sending a message from the active fabric manager to the standby fabric manager if the standby fabric manager has not failed, the message to indicate another path in the switch fabric for the standby fabric manager to send another heartbeat message to the active fabric manager.

### BACKGROUND

In networking environments such as those used in telecommunication and/or data centers, a switch fabric is utilized to rapidly move data. Typically a switch fabric provides a communication medium that includes one or more point-to-point communication links interconnecting one or more nodes (e.g., endpoints, switches, modules, blades, boards, etc.). The switch fabric may operate in compliance with industry standards and/or proprietary specifications. One example of an industry standard is the Advanced Switching Interconnect Core Architecture Specification, Rev. 1.1, published November 2004, or later version of the specification (“the ASI standard”).

Typically a switch fabric includes a switch fabric management architecture to maintain a highly available communication medium and to facilitate the movement of data through the switch fabric. One part of the fabric management architecture is to manage/control the configuration of each node coupled to the edge of the switch fabric (e.g. an endpoint) or a node coupled within the switch fabric (e.g., a switch). As part of a typical fabric management architecture, an active and a standby fabric manager manage/control at least a portion of each node's switch fabric configuration as well as the communication links that may interconnect the nodes coupled to the switch fabric.

In one example, one or more fabric managers are selected/elected for a switch fabric. Once elected, a fabric manager gains ownership of a spanning tree (ST) path. The ST path may include a particular route or path through which an owning fabric manager forwards instructions to other nodes coupled to the switch fabric. Ownership may grant the fabric managers privileged access to the configuration registers for these nodes to configure the nodes to operate on the switch fabric. Thus, a node receiving a configuration request ignores the request if the request was not routed via the ST path associated with an owning fabric manager.

### BRIEF DESCRIPTION OF THE DRAWINGS

FIGS. 1a-e are example illustrations of elements of a switch fabric to include paths to send heartbeat messages between active and standby fabric managers;

FIG. 2 is a block diagram of an example fabric manager architecture;

FIG. 3 is flow chart of an example method to detect a standby fabric manager's failure in the switch fabric; and

FIG. 4 is a flow chart of an example method to detect an active fabric manager's failure in the switch fabric.

### DETAILED DESCRIPTION

As mentioned in the background a typical switch fabric may include an active and a standby fabric manager. In general, a fabric manager is logically associated with or responsive to an endpoint for the switch fabric. The endpoint may include resources (e.g., processing power, memory, etc.) to support the fabric manager. In one example, a fabric manager may be initiated by instructions included in a memory accessible by a processor or control logic on the endpoint. The instructions may also enable the endpoint's control logic to determine whether it will support an active and/or a standby fabric manager for the switch fabric.

In one implementation, an active and a standby fabric manager may monitor the health of each other. For example, each fabric manager may send a message (e.g., heartbeat message) that provides a status (health) of the respective fabric manager. In one example, heartbeat messages are packet-based and indicate the operating or functional status of a fabric manager (e.g., fully or adequately operational). These heartbeat messages may be sent via paths through the switch fabric. When a fabric manager fails to receive a heartbeat message from the other fabric manager, the fabric manager may assume the other fabric manager has failed, e.g., no longer fully operational or coupled to the switch fabric. The fabric manager may then take corrective actions, e.g., failover to become the active fabric manager, select a new standby fabric manager, reset the switch fabric, etc.

In one example, failure of a fabric manager to detect a heartbeat message from another fabric manager may occur even if the other fabric manager has not failed. In this example, failure to detect a heartbeat message from the other fabric manager may be caused by a failed communication link or node. The failed communication link or node may fall along the path in the switch fabric that is used by the other fabric manager to send its heartbeat message. Since a fabric manager may take corrective actions that assume the other fabric manager has failed, this may cause the switch fabric to become unstable as both fabric managers may vie to be the active fabric manager and/or each may select additional fabric managers to replace the supposedly failed other fabric manager. This unstable fabric is problematic in networking systems where high availability and reliability is important and tolerance for an unstable fabric is low.

In one implementation, an endpoint node for a switch fabric includes a fabric manager. This fabric manager may be an active fabric manager for the switch fabric. The endpoint node may also include failover logic responsive to the fabric manager to detect a heartbeat message from a standby fabric manager for the switch fabric. The heartbeat message to be sent from the standby fabric manager via a path in the switch fabric.

The failover logic may set a timer for a duration and reset the timer based on detection of the heartbeat message from the standby fabric manager. If the heartbeat message is not detected after the timer has expired, then the failover logic may obtain a topology of the switch fabric. Based at least in part on the topology, the failover logic may determine whether the standby fabric manager has failed. If the standby fabric manager has failed, the failover logic may failover to another standby fabric manager. If the standby fabric manager has not failed, no failover occurs and the failover logic sends a message from the active fabric manager to the standby fabric manager. The message may indicate another path in the switch fabric for the standby fabric manager to send another heartbeat message to the active fabric manager.

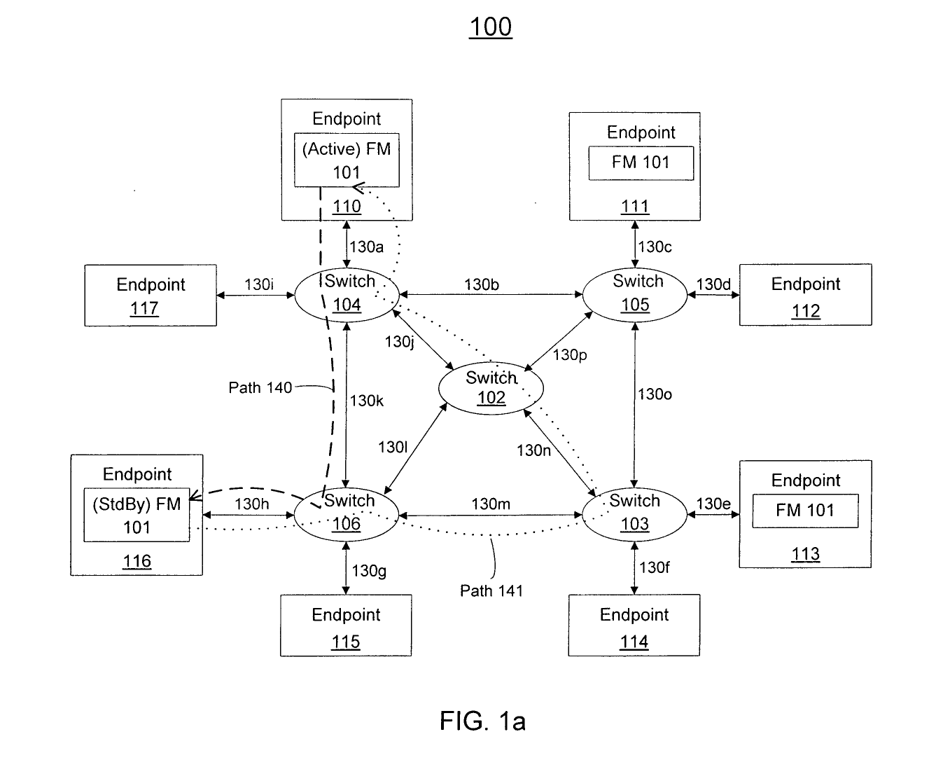

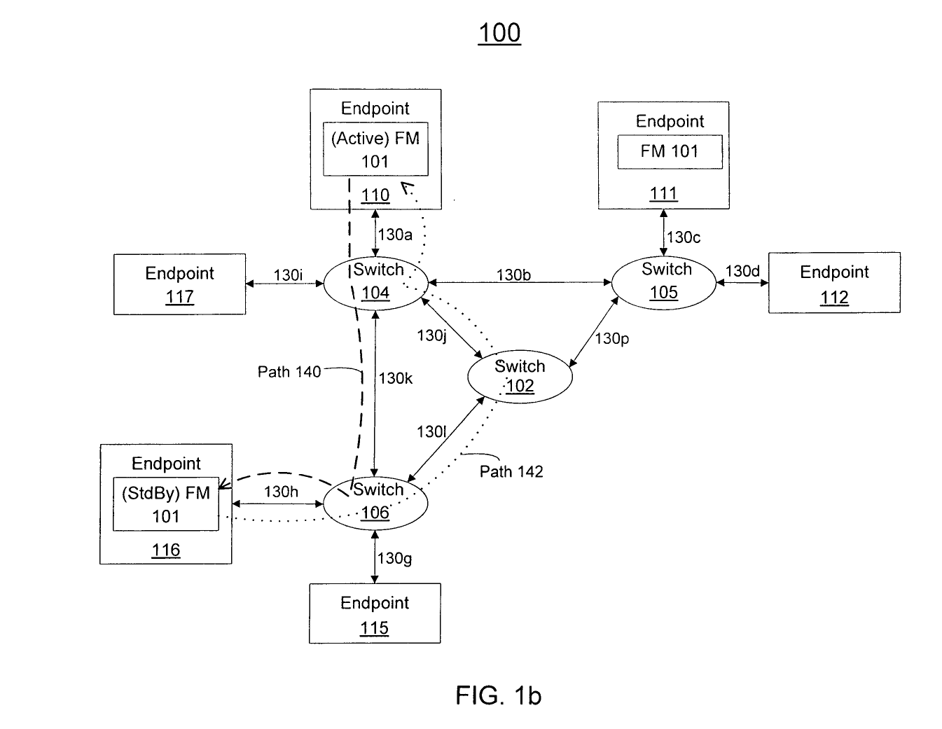

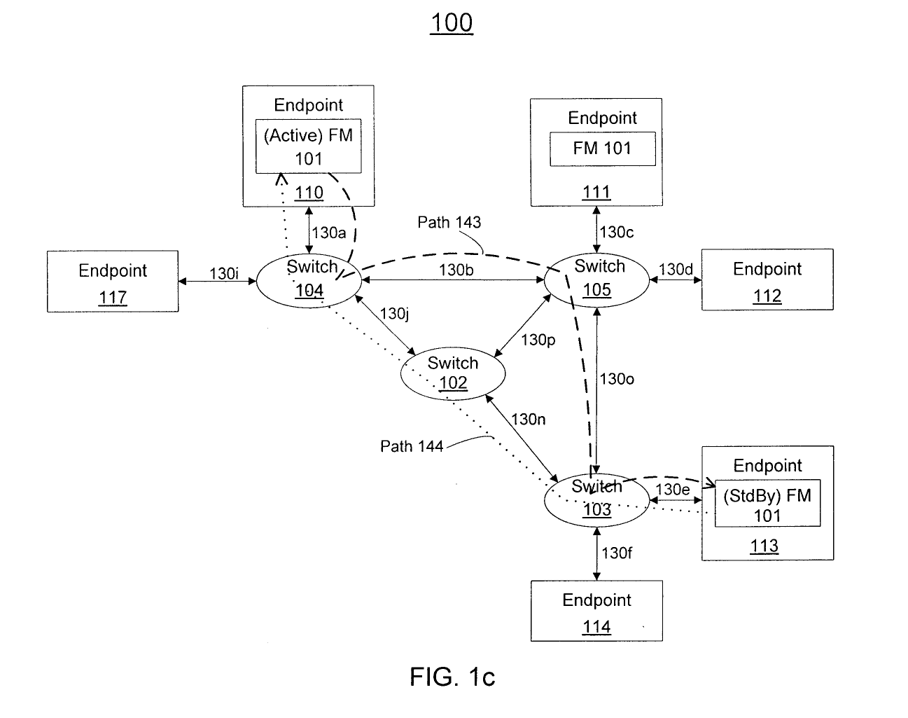

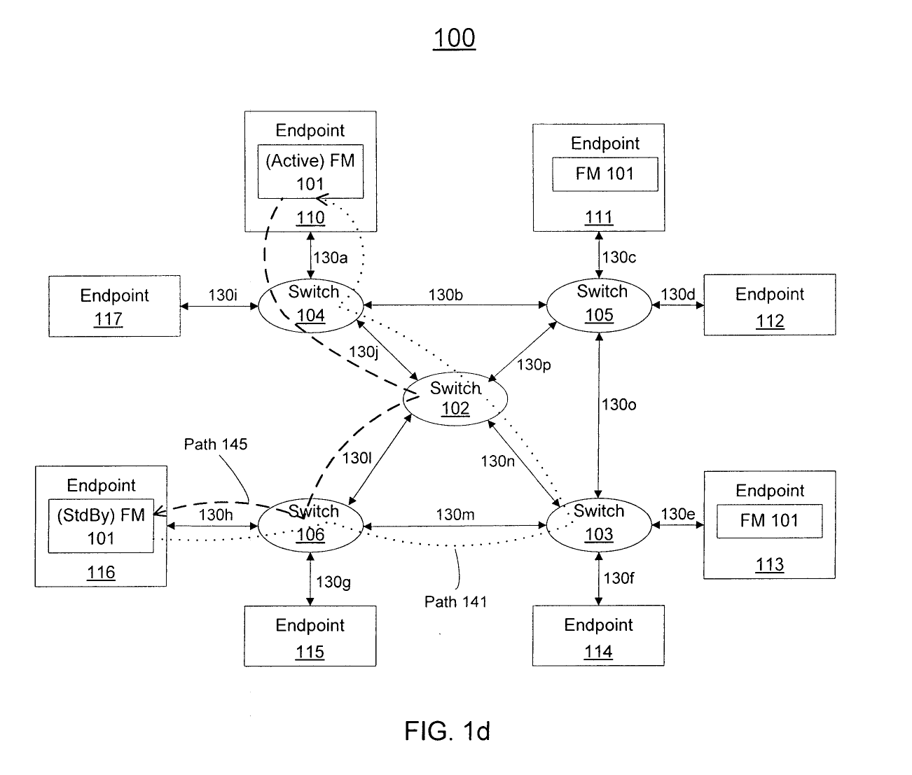

FIG. 1a is an example illustration of elements of switch fabric 100. As shown in FIG. 1a, switch fabric 100 includes various nodes graphically depicted as switches 102-106 and endpoints 110-117. In one example, each of these nodes are coupled to switch fabric 100 with endpoints 110-117 being coupled on the edge of switch fabric 100 and switches 102-106 being coupled within switch fabric 100.

In one example, switch fabric 100 is operated in compliance with the ASI standard. Although this disclosure is not limited to only switch fabrics that operate in compliance with the ASI standard. As depicted in FIG. 1a and in subsequent FIGS. 1b-e endpoints 110, 111, 113 and 116 each include a fabric manager 101. These endpoints, for example, include the resources needed to support a fabric manager that manages/controls at least a portion of the elements of switch fabric 100, e.g., adequate processing power, memory, channel bandwidth, etc.

In one implementation, endpoints 110, 111, 113 and 116 may have indicated an ability to support or willingness to allocate the resources to support a fabric manager. This indication to occur, for example, during initialization of switch fabric 100. Based on each node's indicated ability to support a fabric manager, ASI compliant switch fabric 100 may follow a process described in the ASI standard to elect/select a primary or active fabric manager and a secondary or standby fabric manager. In one example, as depicted in FIG. 1a, endpoint 110 supports the selected active fabric manager and thus includes the active fabric manager 101. Endpoint 116 supports the selected standby fabric manager and thus includes the standby fabric manager 101.

In one example, as depicted in FIG. 1a, switch fabric 100 includes communication links 130a-p. These communication links may include point-to-point communication links that may couple in communication the nodes (e.g., endpoints 110-117, switches 103-106) of switch fabric 100.

In one implementation, the active fabric manager 101 in endpoint 110 and the standby fabric manager 101 in endpoint 116 may communicate their status or health to each other by sending packet-based heartbeat messages to each other. These heartbeat messages may be routed via one or more paths within an ASI compliant switch fabric 100. In one example, these paths may be based on the topology of switch fabric 100. This topology, in one example, is determined/obtained by the primary or active fabric manager following election of that active fabric manager. To obtain the topology, the active fabric manager may complete an enumeration/discovery process described in the ASI standard.

In one example, active fabric manager 101 in endpoint 110 may have obtained a topology of switch fabric 100 that is depicted in FIG. 1a. Paths 140 and 141 may be selected by the active fabric manager 101 in endpoint 110 to send heartbeat messages between active fabric manager 101 in endpoint 110 and standby fabric manager 101 in endpoint 116. Thus, dashed-line path 140 includes a path that follows communication links 130a, 130k and 130h as it passes through switches 104 and 106. Dotted-line path 141 includes a route that follows communication links 130h, 130m, 130n, 130j and 130a as it passes through switches 106, 103, 102 and 104.

As described in more detail below, each endpoint's fabric manager 101 may detect heartbeat messages sent-from one fabric manager to another fabric manager 101 via one or more paths in switch fabric 100 (e.g., paths 140 and 141). In one example, based on a lack of detection of a heartbeat message, a fabric manager may take corrective actions to include using another path to receive or send heartbeat message to another fabric manager or failover to another endpoint that has indicated the resources to support a fabric manager.

Failure to detect a heartbeat message sent along a path in a switch fabric may be the result of a broken path. Causes of a broken path may include, but is not limited, to an element (e.g., switch, endpoint, communication link) failing, malfunctioning or being removed from the fabric. Intermittent failures that may not be detected when an updated topology is obtained by a fabric manager may also lead to a failure to detect a heartbeat message. In one example, based on a failover policy, if after obtaining a topology that reflects no failed elements in a given path, a subsequent failure to detect a heartbeat sent via the given path may indicate an intermittent failure. This intermittent failure may cause the fabric manager to select a different path to send heartbeat messages.

In one example, switch 103 of switch fabric 100 may fail or is removed. As a result, path 141 used by the standby fabric manager 101 in endpoint 116 is broken. So active fabric manager 101 in endpoint 110 is unable to detect heartbeat messages from standby fabric manager 101 in endpoint 116 via path 141. Based on not detecting the heartbeat, according to one example, active fabric manager 101 obtains a topology of switch fabric 100 to determine the operating status of the nodes or communication links in switch fabric 100. That obtained topology, in one example, is illustrated in FIG. 1b.

As depicted in FIG. 1b, the topology obtained by active fabric manager 101 in endpoint 110 may reflect that switch 103 is no longer a functioning part of switch fabric 100. Since path 141 is no longer an option with the new topology shown in FIG. 1b, a new path to route heartbeat messages from standby fabric manager 101 in endpoint 116 is selected by the active fabric manager 101 in endpoint 110. This new path is shown as dotted-line path 142 and includes a path that follows communication links 130h, 130i, and 130a as it passes through switches 106, 102 and 104.

In one implementation, active fabric manager 101 in endpoint 110 may indicate to standby fabric manager 101 in endpoint 116 to send heartbeat messages via path 142 instead of the broken path 141. The standby fabric manager 101 may then stop using the broken path 141 and start to use path 142.

In another example, active manager 101 in endpoint 110 may fail to detect a heartbeat message and after obtaining a topology of switch fabric 100 finds that endpoint 116 has failed or was removed. That obtained topology, in one example is portrayed in FIG. 1c.

As depicted in FIG. 1c, the topology obtained by active fabric manager 101 in endpoint 110 reflects that endpoint 116 is no longer a functioning part of switch fabric 100. In one implementation, as described more below, the active fabric manager 101 in endpoint 110 selects another standby fabric manager 101 in another endpoint. Thus, as shown in FIG. 1c, the active fabric manager 101's selection results in a failover to standby fabric manager 101 in endpoint 113. Dashed-lined path 143 and dotted-line path 144 are then established based on the topology depicted in FIG. 1c to send heartbeat messages between active and standby fabric managers in endpoint 110 and endpoint 113, respectively.

Referring back to FIG. 1a, in one example, standby fabric manager 101 in endpoint 116 does not detect a heartbeat from active fabric manager 101 in endpoint 110. As described more below, the standby fabric manager 101 may wait for a duration of time to account for the possibility that only the path was broken (e.g., initiate a timer). This duration may provide enough time for the active fabric manager 101 in endpoint 110 to notify the standby fabric manager 101 in endpoint 116 it has not failed, not to take corrective action and to detect heartbeat messages along a different path.

In one example, as depicted in FIG. 1d, active fabric manager 101 has not failed but communication link 130k has failed. In this example, active fabric manager 101 in endpoint 110 may send a message to standby fabric manager 101 in endpoint 116 to expect another heartbeat message via an alternate path. This alternate path may be the dashed-line path 145 shown in FIG. 1d.

In one implementation, the duration has elapsed without receiving any messages and/or another heartbeat message from active fabric manager 101 in endpoint 110. So standby fabric manager 101 in endpoint 116 may obtain a topology of switch fabric 100. That topology, in one example, is depicted in FIG. 1e and reflects that endpoint 110 is no longer a part of switch fabric 100's topology. Since switch fabric 100 currently has no endpoint supporting an active fabric manager, standby active manager 101 in endpoint 116 may failover to become the active fabric manager for switch fabric 100. Thus, the active fabric manager is portrayed in FIG. 1e as being in endpoint 116.

In one example, the new active fabric manager 101 in endpoint 116 may then select an endpoint to include the new standby fabric manager for switch fabric 100. As shown in FIG. 1e, endpoints 111 and 113 both include a fabric manager 101. So in this example, active manager 101 in endpoint 116 has selected fabric manager 101 in endpoint 111 to be the new standby fabric manager for switch fabric 100. Dashed-lined path 146 and dotted-line path 147 are then established based on the topology depicted in FIG. 1e to send heartbeat messages between active and standby fabric managers in endpoint 116 and endpoint 111, respectively.

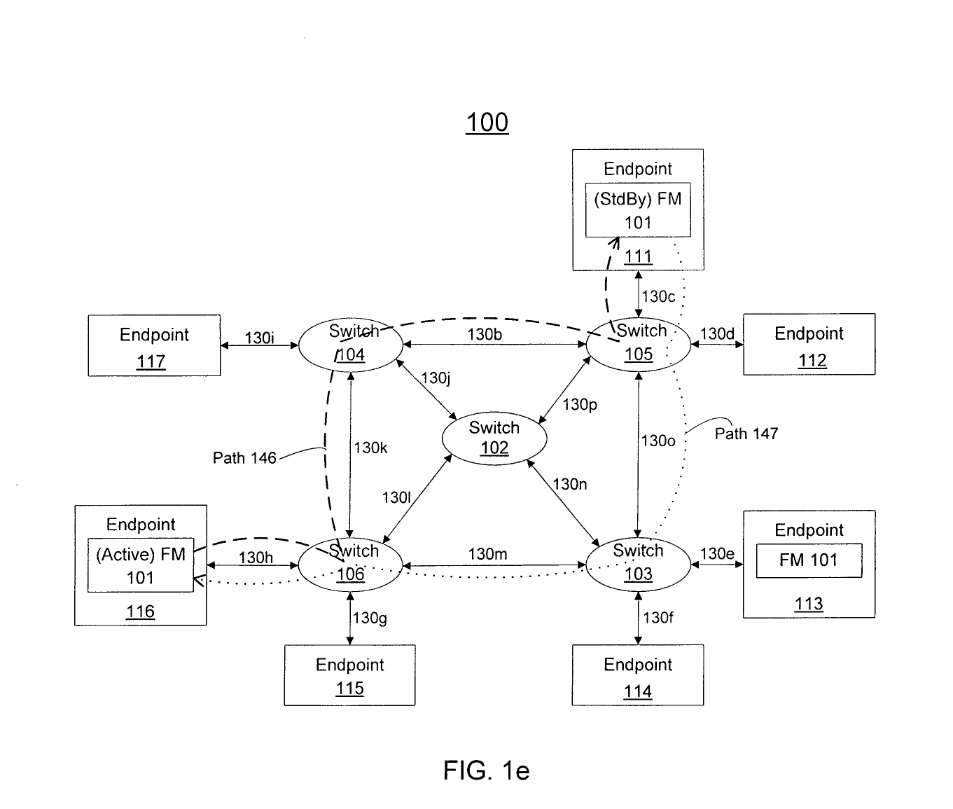

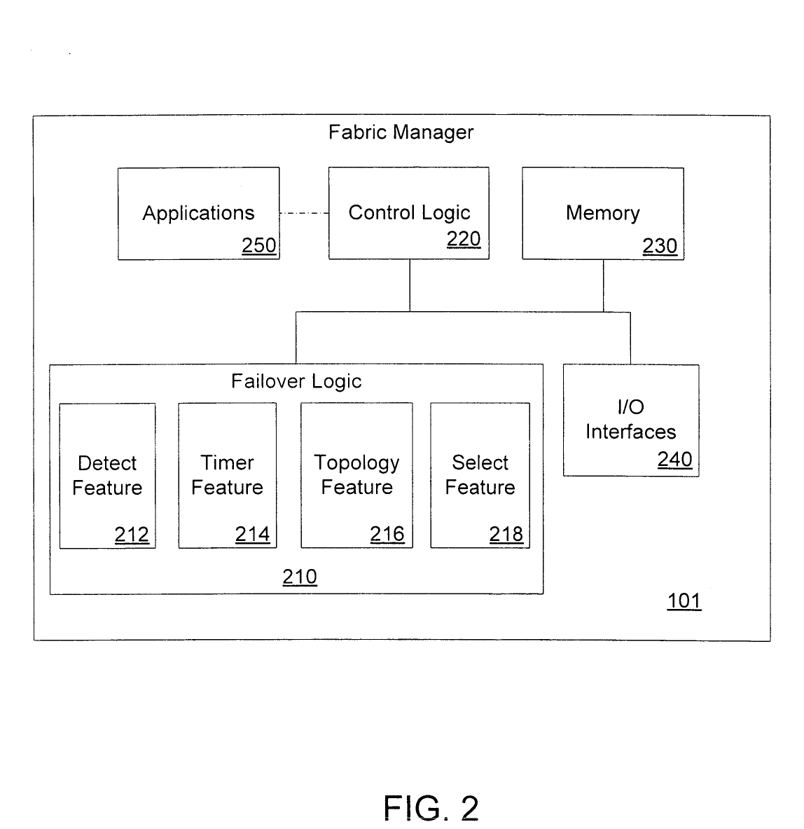

FIG. 2 is a block diagram of an example fabric manager 101 architecture. In FIG. 2, fabric manager 101 includes failover logic 210, control logic 220, memory 230, input/output (I/O) interfaces 240, and optionally one or more applications 250, each coupled as depicted.

As briefly mentioned above, a fabric manager may be initiated by instructions included in a memory (not shown) accessible to an endpoint's control logic. The elements portrayed in FIG. 2's block diagram may be those endpoint resources allocated by the endpoint to support fabric manager 101. Thus, control logic 220 may control the overall operation of fabric manager 101 and may represent any of a wide variety of logic device(s) or executable content an endpoint allocates to implement or support a fabric manager 101. In this regard, control logic 220 may include an endpoint's microprocessor, network processor, microcontroller, field programmable gate array (FPGA), application specific integrated chip (ASIC), or executable content to implement such control features, or any combination thereof.

In FIG. 2, failover logic 210 includes detect feature 212, timer feature 214, topology feature 216 and select feature 218. In one implementation, failover logic 210, responsive to a fabric manager 101, detects a heartbeat message sent from another fabric manager via one or more paths in a switch fabric. Failover logic 210 may also set one or more timers for a duration, determine whether the other fabric manager has failed and may select another path or a replacement fabric manager based on that determination.

In one example, failover logic 210 may represent a portion of the resources allocated by an endpoint to support fabric manager 101. Thus, failover logic 210 may include an endpoint's microprocessor, network processor, microcontroller, field programmable gate array (FPGA), application specific integrated chip (ASIC), or executable content to implement detect feature 212, timer feature 214, topology feature 216 and select feature 218.

According to one example, memory 230 may be a portion of an endpoint's memory (not shown). Memory 230 may be used by failover logic 210 to temporarily store information. For example, information related to the selection of paths to route heartbeat messages or select fabric managers on a switch fabric. Memory 230 may also include encoding/decoding information to facilitate or enable the detection of packet-based heartbeat messages and communicating a path change or a failover based on an obtained topology following a failure to detect one or more heartbeat messages.

I/O interfaces 240 may provide a communications interface via a communication medium or link between fabric manager 101 and a node or an electronic system. As a result, I/O interfaces 240 may enable control logic 220 or failover logic 210 to receive a series of instructions from application software external to the elements allocated to support fabric manager 101. The series of instructions may activate control logic 220 or failover logic 210 to implement one or more features of fabric manager 101.

In one example, fabric manager 101 includes one or more applications 250 to provide internal instructions to control logic 220 or other resources allocated to support fabric manager 101 (e.g., failover logic 210). Such applications 250 may be activated to generate a user interface, e.g., a graphical user interface (GUI), to enable administrative features, and the like. For example, a GUI may provide a user access to memory 230 to modify or update information to facilitate the detection of a heartbeat message and communicating a path change or a failover based on an obtained topology following a failure to detect the heartbeat message.

In another example, applications 250 may include one or more application interfaces to enable external applications to provide instructions to control logic 220 or failover logic 210. One such external application could be a GUI as described above.

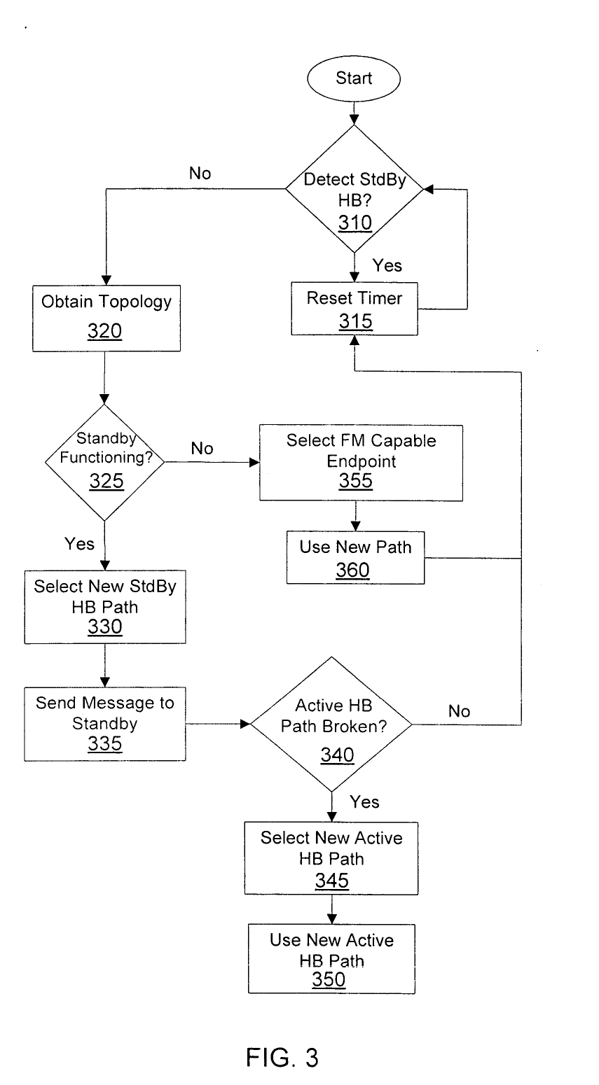

FIG. 3 is a flow chart of an example method to detect a standby fabric manager's failure in switch fabric 100. In this example method, switch fabric 100 operates in compliance with the ASI standard. However, as mentioned above, this disclosure is not limited to only ASI compliant switch fabrics but may also apply to other switch fabric standards or propriety switch fabric specifications.

In one implementation, ASI compliant switch fabric 100 has completed its initialization and both active and standby fabric managers have been elected as depicted by the topology in FIG. 1a. In addition, active fabric manager 101 in endpoint 110 has already determined and communicated the paths to be used to send heartbeat messages. Thus, active fabric manager 101 in endpoint 110 sends heartbeat messages via path 140 and the standby fabric manager in endpoint 116 sends heartbeat messages via path 141.

In block 310, according to one example, failover logic 210 for active fabric manager 101 in endpoint 110 activates detect feature 212. Detect feature 212 may monitor path 141 for heartbeats from standby fabric manager 101 in endpoint 116. Failover logic 210 also activates timer feature 214 to set a timer for a duration. If the timer expires before detect feature 212 detects a heartbeat message from the standby fabric manager 101 in endpoint 116, the process moves to block 320. But if a heartbeat message is detected by detect feature 212, the process moves to block 315.

In one example, the timer duration may be based on one or more factors that may include, but is not limited to, the availability and reliability requirements of switch fabric 100. As a result, a requirement for very high availability and reliability may result in a low tolerance for periods of instability possibly encountered as a fabric manager takes corrective actions following failure to detect a heartbeat. So a short timer duration may be needed to minimize periods of instability. Additionally, the dependability or capability of elements of a switch fabric (e.g., endpoints, switches, communication links) that may fail, may also influence the timer duration. For example, elements that tend to fail more often need a shorter timer duration than elements that rarely fail. Elements that are relatively slow to failover may also need a shorter timer duration as compared to elements that are relatively fast to failover.

In one example, the timer duration may be a configurable duration that may be configured at the time switch fabric 100 is initialized. The timer duration may also be modified by a user (e.g., via I/O interfaces 240 or via applications 250's application interfaces) or dynamically configured based on past operating characteristics of switch fabric 100. For a dynamically configured timer duration, for example, if elements of switch fabric 100 show an increasing trend of failing, the timer duration may be shortened to account for this trend.

In block 315, detect feature 212 has detected the heartbeat message from standby manager 101 in endpoint 116. Based on the detection, timer feature 214 then resets the timer for the duration and the process returns to block 310.

In block 320, detect feature has not detected the heartbeat message from standby manager 101 in endpoint 116. In one example, failover logic 210 activates topology feature 216 to obtain an updated topology of switch fabric 100. As mentioned above, the updated topology may be obtained through an enumeration/discovery process such as described, for example, in the ASI standard. Topology feature 216 may temporarily store information associated with the updated topology, e.g., in memory 230.

In block 325, in one example, failover logic 210 activates select feature 218. Select feature 218 may access the updated topology temporarily stored by topology feature 216 to determine the status of standby fabric manager 101 in endpoint 116. If the updated topology shows that standby fabric manager 101 in endpoint 116 is still a functioning part of switch fabric 100, the process moves to block 330. If not, the process moves to block 355.

In block 330, in one example, the updated topology shows that standby fabric manager 101 in endpoint 116 is still a part of switch fabric 100's topology. Thus, it is likely that an element of switch fabric 100 has malfunctioned, failed, or has been removed. In one example, the topology depicted in FIG. 1b shows that switch 103 has failed, thus breaking path 141. As a result, select feature 218 selects a new path. This new path, in one example, may be path 142 as portrayed in FIG. 1b.

In block 335, in one implementation, active fabric manager 101 in endpoint 110 sends a message to standby fabric manager 101 in endpoint 116. The message indicates path 142 to send heartbeat messages. Standby fabric manager 101 in endpoint 116 then uses path 142 to send subsequent heartbeat messages.

In block 340, in one example, select feature 218 may also determine whether path 140 is broken. Path 140, as portrayed in FIG. 1b, is used by active fabric manager 101 in endpoint 110 to send heartbeat messages to the standby fabric manager 101 in endpoint 116. If path 140 is broken, the process moves to block 345. If not broken, the process returns to block 315 where, in one example, the timer is reset by timer feature 214 and detect feature 212 monitors path 142 to detect heartbeat messages from standby fabric manager 101 in endpoint 116.

In block 345, select feature 218 may select another path in switch fabric 100 for active fabric manager 101 in endpoint 110 to send heartbeat messages to standby fabric manager 101 in endpoint 116. For example, select feature 218 may determine, based on the updated topology, that communication link 130k has failed or is malfunctioning. Thus, select feature 218 may select a path through switch fabric 100 that does not include communication link 130k.

In block 350, active fabric manager 101 in endpoint 110 uses the other path to send heartbeat messages to standby fabric manager 101 in endpoint 116. In one example, this other path is portrayed in FIG. 1d as path 145.

In block 355, in one example, select feature 218 has determined that standby fabric manager 101 in endpoint 116 is no longer part of switch fabric 100's topology. In one implementation, select feature 218 may determine whether there exists at least one other endpoint in the topology that indicates the ability to support a fabric manager. As depicted in FIG. 1c, in one example, both endpoint 111, and 113 indicate an ability to support a fabric manager. Also depicted in FIG. 1c is the selection of endpoint 113 to include the standby fabric manager 101. Thus, endpoint 113 fails over to include the standby fabric manager 101 for switch fabric 100.

In block 360, in one example, select feature 218 selects paths to send heartbeat messages between the active manager 101 in endpoint 110 and the failed over standby fabric manager 101 in endpoint 113. These paths may follow the paths as portrayed in FIG. 1c as paths 143 and 144. Active fabric manager 101 in endpoint 110 then sends a message to the failed over standby fabric manager 101 in endpoint 113. The message to indicate the use of paths 143 and 144 to send or monitor for heartbeat messages. The process then returns to block 315 where in one example, the timer is reset by timer feature 214 and detect feature 212 monitors path 144 to detect heartbeat messages from standby fabric manager 101 in endpoint 113.

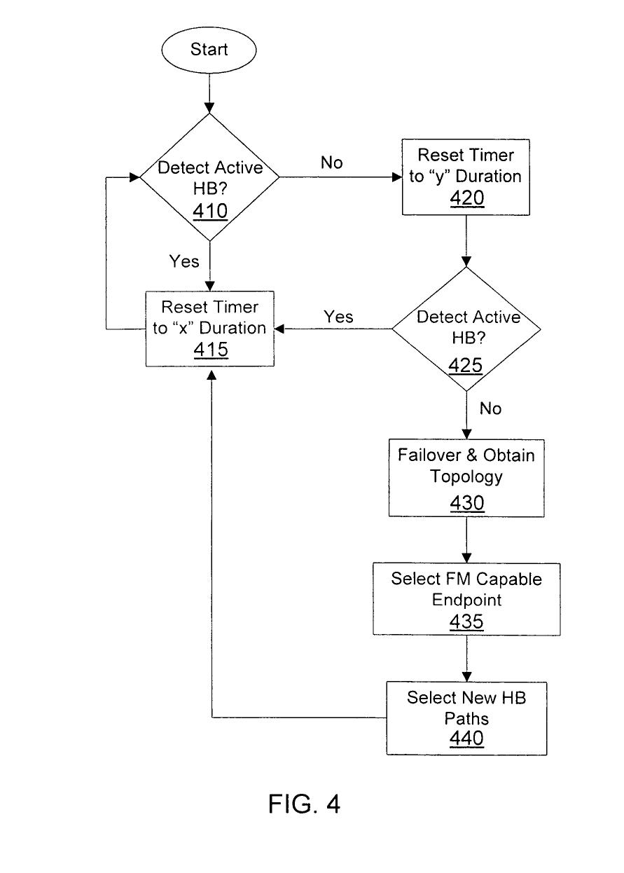

FIG. 4 is a flow chart of an example method to detect an active fabric manager's failure in switch fabric 100. In this example method, switch fabric 100 operates in compliance with the ASI standard and has completed its initialization. As mentioned above, this topology may be depicted in FIG. 1a.

In block 410, in one example, failover logic 210 for standby fabric manager 101 in endpoint 116 activates detect feature 212. Detect feature 212 may monitor path 142 for heartbeat messages from active standby manager 101 in endpoint 110. Failover logic 210 also activates timer feature 214 to set a timer for a duration. If the timer expires before detect feature 212 detects a heartbeat message from the active fabric manager 101 in endpoint 110, the process moves to block 420. But it a heartbeat message is detected before the timer expires, the process moves to block 415.

In block 415, in one example, based on the detection of the heartbeat message by detect feature 212, timer feature 214 resets the timer for duration “x”.

In block 420, in one example, based on detect feature 212 not detecting a heartbeat message, timer feature 2 14 may reset the timer for another duration portrayed as “y” in block 420. In one example, this other duration “y” may be determined based on the expected amount of time if may take active fabric manager 101 in endpoint 110 to send another heartbeat message via another path. This other duration “y” may be equal to or different than duration “x” described for block 415.

In one example, the other duration “y” in block 420 may also be based on the amount of time it may take a message to propagate through switch fabric 100. Duration “y” may also be based on the amount of time it may take the active fabric manager to obtain an updated topology and determine an alternative path to send a heartbeat message.

In one implementation, standby fabric manager 101 in endpoint 116 may receive a message from active fabric manager 101 in endpoint 110 that indicates it is still a part of switch fabric 100 and to expect another heartbeat message via an alternate given path. For example, the topology depicted in FIG. 1d shows communication link 130k is no longer part of switch fabric 100. Thus, the alternate given path may be path 145. As a result, detect feature 212 may monitor path 145 for the other heartbeat message. If the heartbeat message is detected, the process returns to block 415. If the heartbeat message is not detected, the process moves to block 430.

In block 430, in one example, standby fabric manager 101 in endpoint 116 based on the timer set in block 420 expiring without receiving the other heartbeat, begins failover activities to become the active fabric manager for switch fabric 100. Thus, in this example, failover logic 210 for standby fabric manager 101 in endpoint 116 activates topology feature 216 to obtain a topology of switch fabric 100. Topology feature 216 may temporarily store information associated with the obtained topology in a memory, e.g., memory 230.

In block 435, in one example, failover logic 210 activates select feature 218. Select feature 218 may access the obtained topology to determine whether there exists at least one other endpoint in the topology that indicates the ability to support a fabric manager. As depicted in FIG. 1e, in one example, both endpoints 111, and 113 indicate an ability to support a fabric manager. In one example, as portrayed in FIG. 1e, select feature 218 selects endpoint 111 to include standby fabric manager 101.

In block 440, in one example, select feature 218 selects paths to send heartbeat messages between the failed over active fabric manager 101 in endpoint 116 and the newly selected standby fabric manager 101 in endpoint 111. These paths may follow the paths portrayed by paths 146 and 147 in FIG. 1e. Failed over active fabric manager 101 in endpoint 116 then sends a message to the newly selected standby fabric manager 101 in endpoint 111. The message to indicate the use of paths 146 and 147 to send or monitor for heartbeat messages. The process then returns to block 415 where, in one example, the timer is reset by timer feature 214 and detect feature 212 monitors path 147 to detect heartbeat messages from the newly selected standby fabric manager 101 in endpoint 111.

Referring again to switch fabric 100 in FIG. 1a-e. In one example, switch fabric 100 may be part of a modular platform system. The modular platform system may include one or more modular platforms or shelves. These shelves may each include a backplane to receive and couple to boards. Endpoints 110-117 and switches 102-106 may reside on these boards and at least a portion of communication links 130a-130p may be routed through the backplane.

In one implementation, switch fabric 100 may be part of a modular platform system operated in compliance with industry standards such as the PCI Industrial Computer Manufacturers Group (PICMG), Advanced Telecommunications Computing Architecture (AdvancedTCA) Base Specification, PICMG 3.0 Rev. 1.0, published Dec. 30, 2002, or later versions of the specification (“the AdvancedTCA standard”). Although this disclosure is not limited to only AdvancedTCA compliant modular platform systems but may also include systems operated in compliance with other industry standards such as, Peripheral Component Interconnect (PCI), Compact Peripheral Component Interface (cPCI), VersaModular Eurocard (VME), or other types of industry standards governing the design and operation of systems that may include a switch fabric.

In one example, elements of switch fabric 100 are designed to operate in compliance with and to forward data using one or more communication protocols described by sub-set specifications to the AdvancedTCA specification. These sub-set specifications are typically referred to as the “PICMG 3.x specifications.” The PICMG 3.x specifications include, but are not limited to, Ethernet/Fibre Channel (PICMG 3.1), Infiniband (PICMG 3.2), StarFabric (PICMG 3.3), PCI-Express/Advanced Switching Interconnect (PICMG 3.4), Advanced Fabric Interconnect/S-RapidIO (PICMG 3.5) and Packet Routing Switch (PICMG 3.6).

Referring again to memory 230 in FIG. 2. Memory 230 may include a wide variety of memory media including but not limited to volatile memory, non-volatile memory, flash, programmable variables or states, random access memory (RAM), read-only memory (ROM), flash, or other static or dynamic storage media. In one example, machine-readable instructions can be provided to memory 230 from a form of machine-accessible medium. A machine-accessible medium may represent any mechanism that provides (i.e., stores and/or transmits) information or content in a form readable by a machine (e.g., switches 102-106, endpoints 110-117, failover logic 210, control logic 220). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

References made in the specification to the term “responsive to” are not limited to responsiveness to only a particular feature and/or structure. A feature may also be “responsive to” another feature and/or structure and also be located within that feature and/or structure. Additionally, the term “responsive to” may also be synonymous with other terms such as “communicatively coupled to” or “operatively coupled to,” although the term is not limited in his regard.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

What is claimed is:

1. In a switch fabric including an active fabric manager and a standby fabric manager, a method comprising:
setting a timer for a duration; and
resetting the timer based on detection of a heartbeat message from the standby fabric manager via a path in the switch fabric, wherein if the heartbeat message is not detected after the timer has expired:
determining whether the standby fabric manager has failed based, at least in part, on a topology for the switch fabric,
failing over to another standby fabric manager if the standby fabric manager has failed,
sending a message from the active fabric manager to the standby fabric manager if the standby fabric manager has not failed, the message to indicate another path in the switch fabric for the standby fabric manager to send another heartbeat message to the active fabric manager.

2. A method according to claim 1, wherein the heartbeat message from the standby fabric manager via the path comprises the path through one or more switch nodes and one or more communication links for the switch fabric.

3. A method according to claim 2, wherein based on a failure of a switch node from among the one or more switch nodes the heartbeat message is not detected.

4. A method according to claim 3, wherein the other path comprises the other path through one or more switch nodes and one or more communication links that does not include the failed switch node.

5. A method according to claim 2, wherein based on a failure of a communication link among the one or more communication links, the heartbeat message is not detected.

6. A method according to claim 5, wherein the other path comprises the other path through one or more switch nodes and one or more communication links that does not include the failed communication link.

7. A method according to claim 1, wherein the duration comprises a configurable duration.

8. A method according to claim 1, wherein the active fabric manager is supported by a first endpoint node for the switch fabric and the standby fabric manager is supported by a second endpoint node for the switch fabric.

9. A method according to claim 8, wherein the switch fabric is operated in compliance with the Advanced Switching Interconnect standard and the topology comprises the topology obtained by the active fabric manager via a discovery process.

10. A method according to claim 9, wherein failing over to the other standby fabric manager comprises failing over based on a third endpoint node for the switch fabric indicating adequate resources to support a fabric manager, the indication detected by the active fabric manager when obtaining the topology.

11. In a switch fabric including an active fabric manager and a standby fabric manager, a method comprising:
setting a timer for a duration; and
resetting the timer based on detection of a heartbeat message from the active fabric manager via a path in the switch fabric, wherein if the heartbeat message is not detected after the timer set for the duration expires:
resetting the timer to another duration, the timer to be reset when another heartbeat message from the active fabric manager is received via another path, if the other heartbeat message is not received after the timer reset to the other duration expires:
failing over the standby fabric manager to become active fabric manager,
selecting new standby fabric manager based on a topology for the switch fabric.

12. A method according to claim 11, wherein the heartbeat message from the active fabric manager via the path comprises the path through one or more switch nodes and one or more communication links for the switch fabric.

13. A method according to claim 11, wherein the duration comprises a configurable duration based on the reliability of the active fabric manager, the higher the reliability, the shorter the duration.

14. A method according to claim 11, wherein the other duration comprises the other duration based on an amount of time for the active fabric manager to obtain a topology, select the other path and the standby fabric manager to detect the other heartbeat message sent from the active fabric manager.

15. A method according to claim 11, wherein the active fabric manager is supported by a first endpoint node for the switch fabric and the standby fabric manager is supported by a second endpoint node for the switch fabric.

16. A method according to claim 15, wherein the switch fabric is operated in compliance with the Advanced Switching Interconnect standard and the topology comprises the topology obtained by the failed over fabric manager via a discovery process.

17. A method according to claim 16, wherein selecting the new standby fabric manager comprises selecting based on a third endpoint node for the switch fabric indicating adequate resources to support a fabric manager, the indication detected by the failed over active fabric manager when obtaining the topology.

18. An endpoint node for a switch fabric comprising:
a fabric manager to be an active fabric manager for the switch fabric; and
a failover logic responsive to the fabric manager, the failover logic to:
set a timer for a duration; and
reset the timer based on detection of a heartbeat message from a standby fabric manager for the switch fabric, the heartbeat message sent by the standby fabric manager via a path in the switch fabric, wherein if the heartbeat message is not received after the timer has expired the failover logic to:
determine whether the standby fabric manager has failed based at least in part on a topology of the switch fabric,
failover to another standby fabric manager if the standby fabric manager has failed,
send a message to the standby fabric manager if the standby fabric manager has not failed, the message to indicate another path in the switch fabric to send another heartbeat message to the endpoint.

19. An endpoint node according to claim 18, wherein the standby fabric manager is supported by a second endpoint node for the switch fabric.

20. An endpoint node according to claim 19, wherein the switch fabric is operated in compliance with the Advanced Switching Interconnect standard and the topology comprises the topology obtained by the active fabric manager via a discovery process.

21. An endpoint node according to claim 20, wherein failing over to the other standby fabric manager comprises failing over based on a third endpoint node for the switch fabric indicating adequate resources to support a fabric manager for the switch fabric, the indication detected by the active fabric manager when obtaining the topology.

22. An endpoint node according to claim 21, wherein adequate resources comprise processing and memory capabilities to support a fabric manager for the switch fabric.

23. An endpoint node according to claim 18, the endpoint node further comprising:
a memory to store executable content; and
a control logic, communicatively coupled with the memory, to execute the executable content to implement the fabric manager.

24. A switch fabric comprising:
a first endpoint node including a fabric manager to be the active fabric manager for the switch fabric; and
a second endpoint node including a fabric manager to be the standby fabric manager for the switch fabric, wherein each endpoint node includes failover logic responsive to each endpoint node's fabric manager, the failover logic responsive to the standby fabric manager to:
set a timer for a duration; and
reset the timer based on detection of a heartbeat message from the active fabric manager via a path in the switch fabric, wherein if the heartbeat message is not received after the timer has expired:
reset the timer for another duration, the timer to be reset when another heartbeat message from the active fabric manager is received via another path, if the other heartbeat message is not received after the timer reset to the other duration expires:
failover the standby fabric manager on the second endpoint node to become active fabric manager for the switch fabric,
select a new standby fabric manager for the switch fabric based on a topology.

25. A system according to claim 24, wherein the new standby fabric manager is selected from among at least one endpoint node for the switch fabric that includes a fabric manager, the at least one endpoint node different than the first and second endpoint nodes for the switch fabric.

26. A system according to claim 24, wherein the failover logic responsive to the active fabric manager is to:
set a timer for a duration; and
reset the timer based on detection of a heartbeat message from the standby fabric manager via a path in the switch fabric, wherein if the heartbeat is not received after the timer has expired:
determine whether the standby fabric manager has failed based at least in part on a topology,
failover to another standby fabric manager if the standby fabric manager has failed,
send a message to the standby fabric manager if the standby fabric manager has not failed, the message to indicate another path in the switch fabric for the standby fabric manager to send another heartbeat message to the active fabric manager.

27. A system according to claim 26, wherein the other standby fabric manager is selected from among at least one endpoint node for the switch fabric that includes a fabric manager, the at least one endpoint node different than the first and second endpoint nodes for the switch fabric.

28. A system according to claim 24, wherein the switch fabric is part of a modular platform system operated in compliance with the AdvancedTCA standard, the first endpoint and the second endpoint to each reside on a board received and coupled to a backplane in the modular platform system.

29. A machine-accessible medium comprising content, which, when executed by an endpoint node in a switch fabric that includes an active fabric manager and a standby fabric manager, causes the endpoint node to:
set a timer for a duration; and
reset the timer based on detection of a heartbeat message from the standby fabric manager via a path in the switch fabric, wherein if the heartbeat is not detected after the timer has expired:
determine whether the standby fabric manager has failed based, at least in part, on a topology,
failover to another standby fabric manager if the standby fabric manager has failed,
send a message from the active fabric manager to the standby fabric manager if the standby fabric manager has not failed, the message to indicate another path in the switch fabric for the standby fabric manager to send another heartbeat message to the active fabric manager.

30. A machine-accessible medium according to claim 29, wherein the heartbeat message from the standby fabric manager via the path comprises the path through one or more switch nodes and one or more communication links for the switch fabric.

31. A machine-accessible medium according to claim 30, wherein based on a failure of a switch node from among the one or more switch nodes the heartbeat message is not detected.

32. A machine-accessible medium according to claim 31, wherein the other path comprises the other path through one or more switch nodes and one or more communication links that does not include the failed switch node.
